(19) United States
(12) Patent Application Publication
(10) Pub. No.: US 2008/0238109 A1
(43) Pub. Date: Oct. 2, 2008

(54) Structure of a hooked fastener

(76) Inventor: Chien-Hoa Huang, Chiayi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,665

(22) Filed: Mar. 28, 2007

(51) Int. Cl. E05C 19/10

(52) U.S. Cl. 292/95

(57) ABSTRACT

A hooked fastener includes a holding member, a covering on the holding member, a hooked plate and a rotary sleeve between the holding member and the covering, and a coupling piece for the hooked plate to be hooked over; the holding member has a rail, and the hooked plate has on one side a post-shaped protrusion received in the rail; the rail of the holding member and the post-shaped protrusion of the hooked plate together will serve as a guiding means for the hooked plate when the rotary sleeve is wrenched so as to move the hooked plate; the hooked plate has a guide rail on the other side, and the holding member has a guide rod secured therein and passed through the guide rail of the hooked plate; the guide rail and the guide rod together also will serve as a guiding means for the hooked plate.

### BACKGROUND OF THE INVENTION

1. Field of the invention

The present invention relates to an improvement on a hooked fastener, more particularly one, which can be smoothly operated so as to make a hooked plate tightly hooked over a coupling piece thereof.

2. Brief Description of the Prior Art

Cold storages and prefabricated houses comprise many wall plank members, and several coupling devices fastening every two adjacent ones of the wall plank members to each other. Such a coupling device usually includes a hooked plate, a rotary sleeve, a holding member, and a coupling piece.

The hooked plate has a hook portion, and a through hole, and is held in the holding member. The rotary sleeve has an acting protruding portion, and is passed through the through hole of the hooked plate such that the rotary sleeve can be wrenched in order for the acting protruding portion to cause displacement of the hooked plate. The coupling piece has a rod part, and the hooked plate will be hooked over the rod part when it is angularly displaced to a fastening position.

More detailedly, the hooked plate has two post-shaped protrusions on a same diagonal thereof, and the holding member has two guide grooves each receiving a corresponding said post-shaped protrusion; each of the guide grooves has a curved section, and a straight section. In addition, a covering is secured over the holding member, and each of the covering and the holding member has a position-limiting hollow portion, which has a slope, and receives the acting protruding portion of the rotary sleeve, and which doesn't abut the guide grooves. Thus, the hooked plate will be firm in the fastening position without possibility of falling loose or falling off. And, the hooked plate can be angularly displaced more smoothly when the rotary sleeve is wrenched.

However, the holding member and the covering are made plastics, and will be caused to change shape by pressure from the contents of a wall plank member when they together are inserted in the wall plank member. Therefore, the guide grooves of the holding member change their shape, and can't effectively serve as the guiding means for the hooked plate together with the post-shaped protrusions, and in turn the hooked plate can't be smoothly moved.

### SUMMARY OF THE INVENTION

It is a main object of the present invention to provide an improvement on a hooked fastener to overcome the above-mentioned problems.

A hooked fastener according to an embodiment of the present invention includes a holding member, a covering on the holding member, a hooked plate and a rotary sleeve fitted between the holding member and the covering, and a coupling piece; the holding member with the covering and the hooked plate are fitted in a first wall plank member while the coupling piece is fitted in a second wall plank member for allowing the hooked plate to be hooked over to fasten the wall plank members to each other. The holding member has a rail, and the hooked plate has on one side a post-shaped protrusion received in the rail; the rail of the holding member and the post-shaped protrusion of the hooked plate together will serve as a guiding means for the hooked plate when the rotary sleeve is wrenched so as to move the hooked plate. The hooked plate has a guide rail on the other side, and the holding member has a guide rod secured therein and passed through the guide rail of the hooked plate; the guide rail and the guide rod together also will serve as a guiding means for the hooked plate. Because of existence of the guide rail and the guide rod, the hooked plate still can be guided to move smoothly so as to be tightly hooked over the coupling piece even if the rail of the holding member changed its shape slightly when the holding member was inserted in the first wall plank member.

### BRIEF DESCRIPTION OF THE DRAWINGS

The present invention will be better understood by referring to the accompanying drawings, wherein:

FIG. 1 is an exploded perspective view of the present invention,

FIG. 2 is a front view of the present invention,

FIG. 3 is a front view of the present invention in use (1),

FIG. 4 is a front view of the present invention in use (2),

FIG. 5 is a front view of the second preferred embodiment (1),

FIG. 6 is a front view of the second preferred embodiment (2),

FIG. 7 is a front view of the third preferred embodiment (1),

FIG. 8 is a front view of the third preferred embodiment (2),

FIG. 9 is a front view of the third preferred embodiment (3),

FIG. 10 is a front view of the third preferred embodiment (4),

FIG. 11 is a front view of the third preferred embodiment (5),

FIG. 12 is a front view of the third preferred embodiment (6),

FIG. 13 is a front view of the third preferred embodiment (7),

FIG. 14 is a front view of the third preferred embodiment (8),

FIG. 15 is a front view of the fourth preferred embodiment, and

FIG. 16 is a front view of the fourth preferred embodiment in use.

### DETAILED DESCRIPTION OF THE PREFERRED EMBODIMENTS

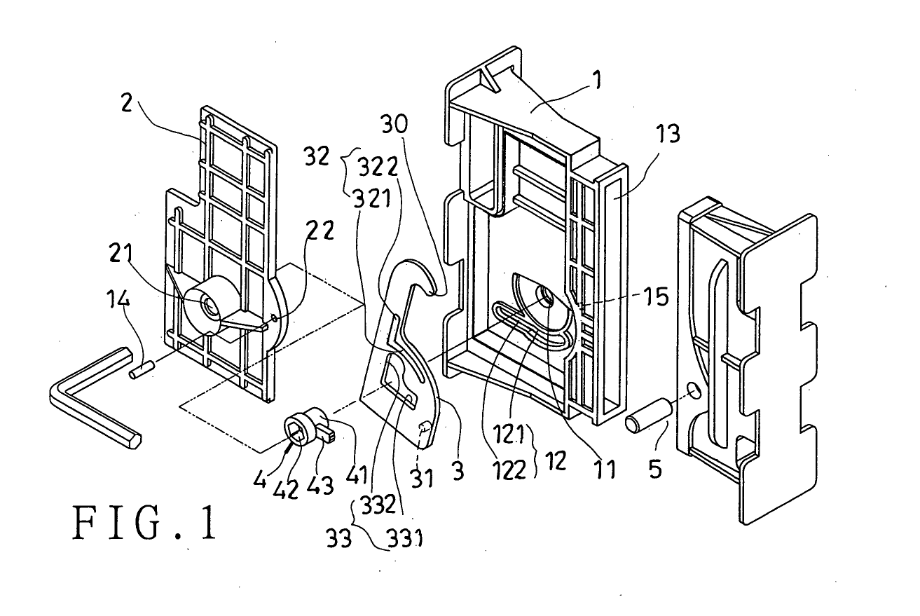

Referring to FIG. 1, an improvement on a hooked fastener structure of the present invention includes a holding member 1, a covering part 2, a hooked plate 3, a rotary sleeve 4, and a coupling piece 5 for the hooked plate 3 to be hooked over.

The hooked plate 3 is received in and supported with the holding member 1. The holding member 1 has a through hole 11, through which the rotary sleeve 4 is passed. The holding member 1 has at least one and no more than three rails 12 around the through hole 11 on one side thereof. The hooked plate 3 is positioned around the rotary sleeve 4 in such a manner as to be caused to move by the rotary sleeve 4 when the rotary sleeve 4 is angularly displaced. The hooked plate 3 has on a first side thereof several post-shaped protrusions 31 each received in a corresponding said rail 12 of the holding member 1. Each of the rails 12 has a curved section 121 for serving to guide the hooked plate 3 together with a corresponding said post-shaped protrusion 31 in order for the hooked plate 3 to be angularly displaced. Each of the rails 12 further has a straight section 122 connected to the curved section 121, which is provided for guiding the hooked plate 3 in order for the hooked plate 3 to move inwardly so as to be tightly hooked over the coupling piece 5. The holding member 1 has a slot 13 facing the coupling piece 5 for allowing the hooked plate 3 to pass through so as to be hooked over the coupling piece 5. The holding member 1 further has a fixing hole 15 thereon, and a guide rod 14 securely inserted in the fixing hole 15.

The covering part 2 is positioned over one side of the holding member 1, and has a through hole 21 facing the through hole 11 of the holding member 1. The covering part 2 further has a fixing hole 22 facing the fixing hole 15 of the holding member 1, and the guide rod 14 is securely inserted in the fixing hole 22.

The hooked plate 3 is metallic and plate-shaped, and has a hook portion 30 to be hooked over the coupling piece 5. The hooked plate 3 has a guide rail 32 on a second side facing in an opposite direction of the first side besides having the post-shaped protrusions 31 on the first side, which are each received in a corresponding said rail 12 of the holding member 1. The guide rail 32 has a curved section 321 for guiding the hooked plate 3 so as to help to cause angular displacement of the hooked plate 3. The guide rail 32 further has a straight section 322 connected to the curved section 321, which is provided to guide the hooked plate 3 in order for the hooked plate 3 to move inwardly so as to be tightly hooked over the coupling piece 5. The guide rod 14 is passed through the guide rail 32 of the hooked plate 3, and secured in the fixing holes 15 and 22 of the holding member 1 and the covering part 2 at two ends. The hooked plate 3 further has a position-limiting hollow portion 33. The position-limiting portion 33 has an acted section 331, and a fixing section 332, which is perpendicular and connected to the acted section 331 as well as being parallel to the straight section 322 of the guide rail 32.

The rotary sleeve 4 has a sleeve part 41 having a hexagonal wrench hole 42. The rotary sleeve 4 is partly received in the through hole 11 of the holding member 1 with the hexagonal wrench hole 42 facing the through hole 21 of the covering part 2. The rotary sleeve 4 has an acting protrusion 43 protruding from the sleeve part 41. The sleeve part 41 and the acting protrusion 43 are received in the position-limiting hollow portion 33 of the hooked plate 3.

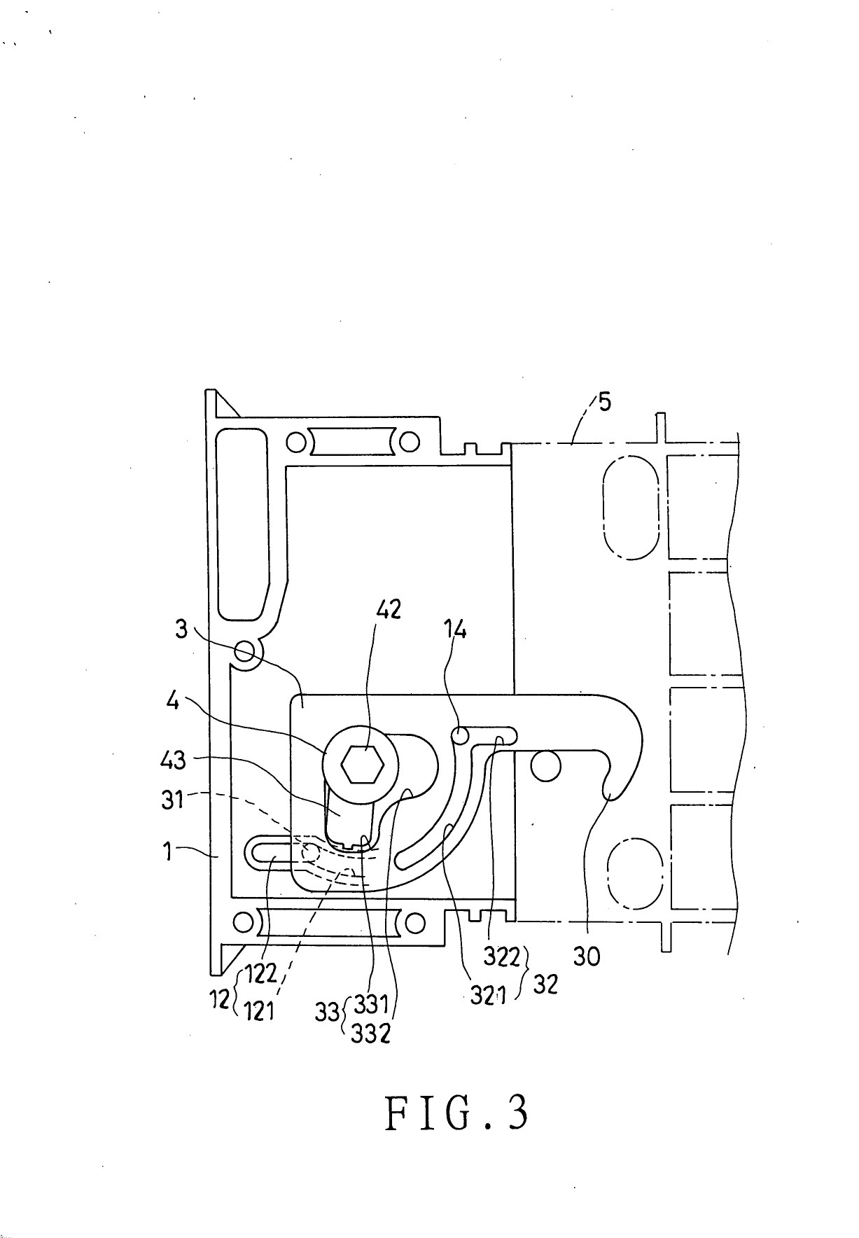

In use, referring to FIG. 3 as well, first the holding member 1 with the hooked plate 3 are inserted in and fixed to a first wall plank member, and the coupling piece 5 is inserted in and fixed to a second wall plank member. The wall plank members are positioned together with the holding member 1 being faced with and near to the coupling piece 5. Next, a wrench tool is inserted in the hexagonal wrench hole 42, and turned so as to cause angular displacement of the rotary sleeve 4; thus, the acting protrusion 43 of the rotary sleeve 4 exerts force on the acted section 331 of the position-limiting hollow portion 33 of the hooked plate 3 to cause angular displacement of the hooked plate 3 with the help of the curved section 321 of the guide rail 32 of the hooked plate 3 as well as the guide rod 14 of the holding member 1; when the hooked plate 3 is being moved, the post-shaped protrusions 31 of the hooked plate 3 and the rails 12 of the holding member 1 will serve to guide the hooked plate 3, thus helping to increase smoothness of motion of the hooked plate 3. Consequently, the hooked portion 30 of the hook plate 3 sticks out from the holding member 1 through the slot 13, and is hooked over the coupling piece 5.

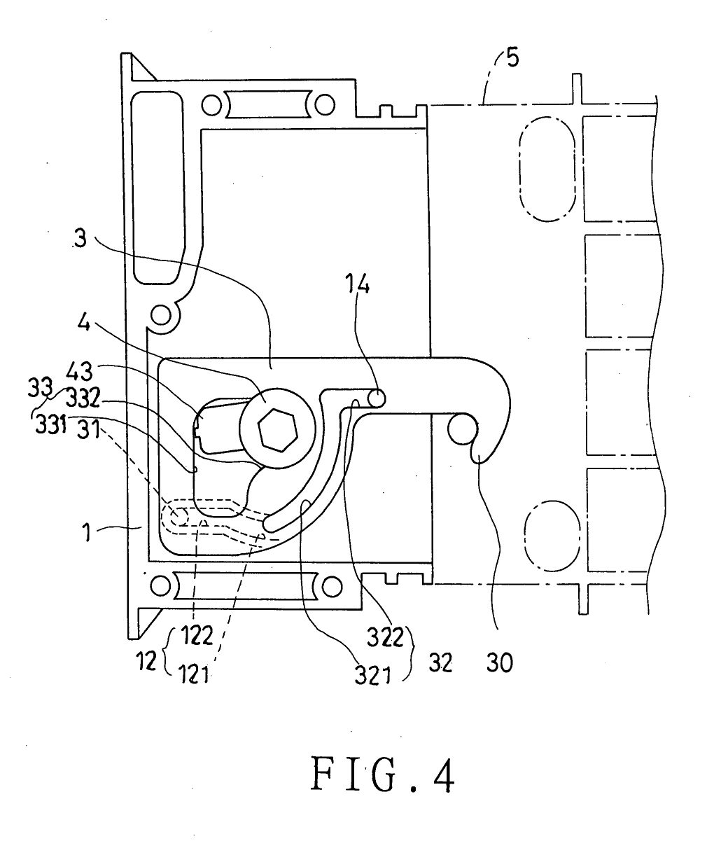

Referring to FIG. 4, the user continues to wrench the rotary sleeve 4 by means of using the wrench tool after the hooked portion 30 of the hook plate 3 is hooked over the coupling piece 5; thus, the hooked plate 3 is guided to move inwardly of the holding member 1 along a straight line with the help of the straight sections 322 and 122 of the guide rail 32 and the rails 12; at the same time, the acting protrusion 43 of the rotary sleeve 4 will change direction to be relocated from the acted section 331 to the fixing section 332 of the position-limiting hollow portion 33 of the hooked plate 3. Therefore, the sleeve part 41 is detained in the fixing section 332, the hook portion 30 of the hooked plate 3 tightly hooked over the coupling piece 5, and the first and the second wall plank members are securely joined and closely in touch with each other.

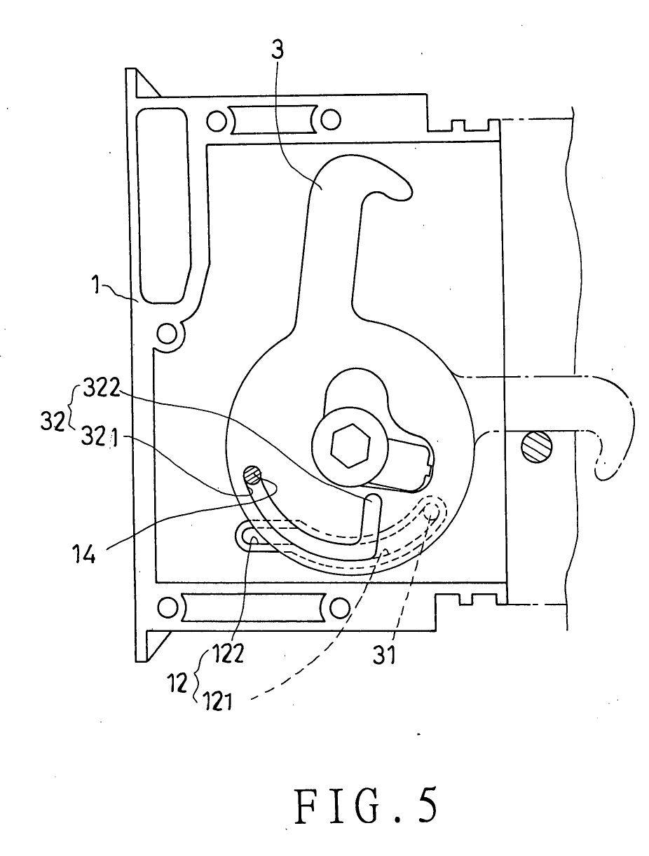

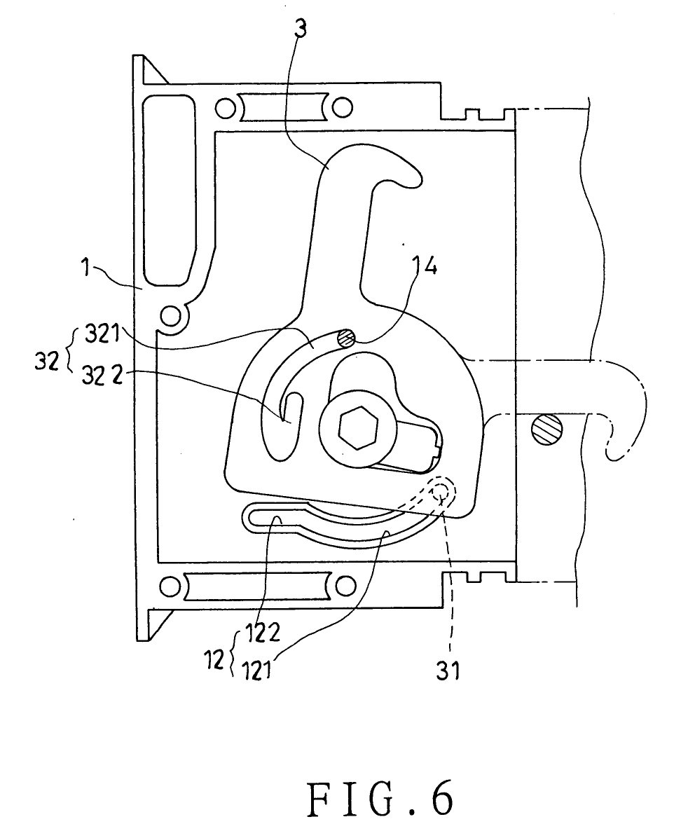

Referring to FIGS. 5 and 6, a second preferred embodiment of a hooked fastener is provided, which includes a hooked plate 3; the hooked plate 3 has a guide rail 32 on one side thereof, and a post-shaped protrusion 31 on the other side; the guide rail 32 has a curved section 321 for guiding the hooked plate 3 so as to help cause angular displacement of the hooked plate 3; the guide rail 32 further has a straight section 322 connected to the curved section 321, which is provided for guiding the hooked plate 3 in order for the hooked plate 3 to move inwardly so as to be tightly hooked over the coupling piece 5. The post-shaped protrusion 31 is received in the rail 12 formed on the holding member 1.

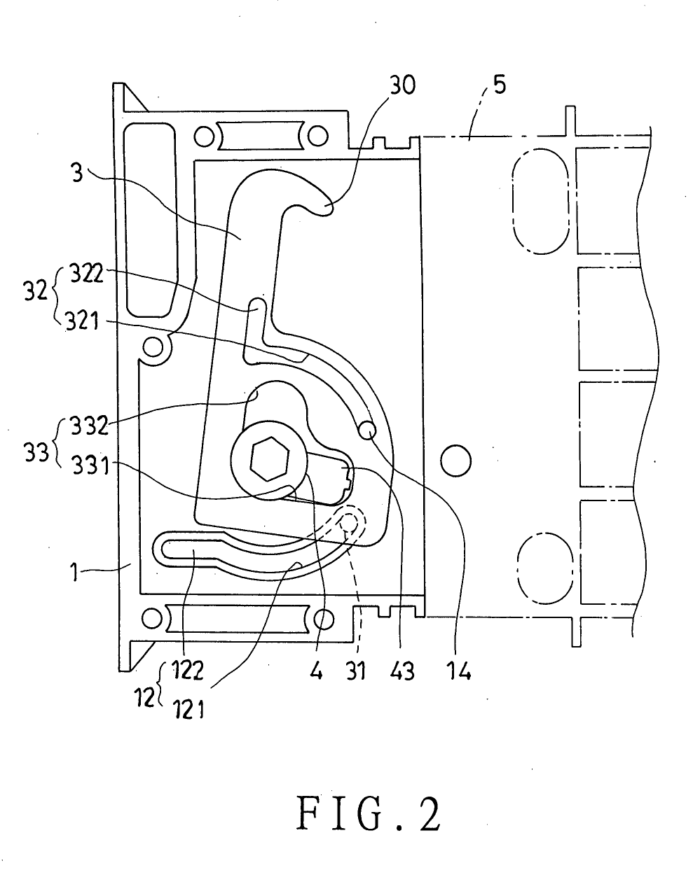

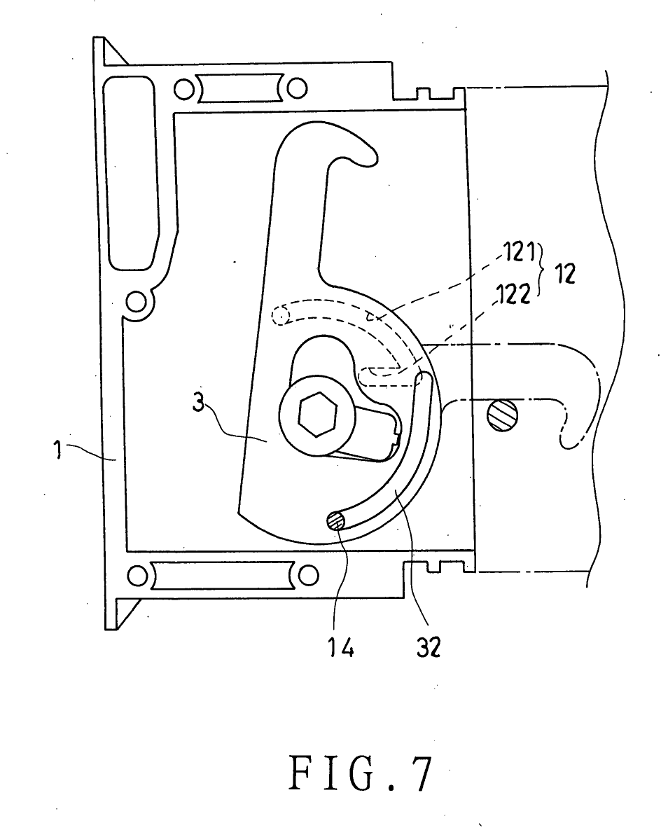

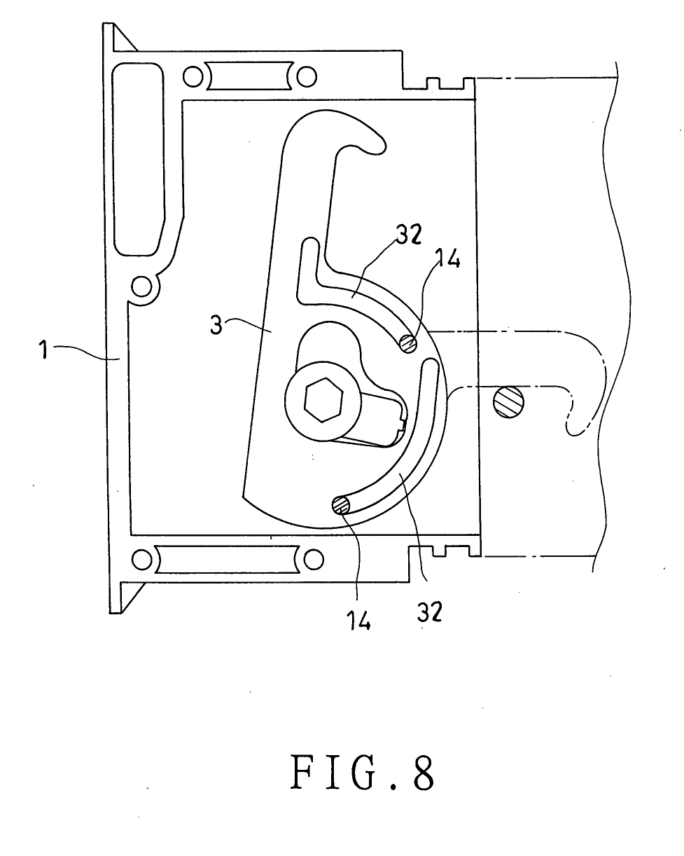

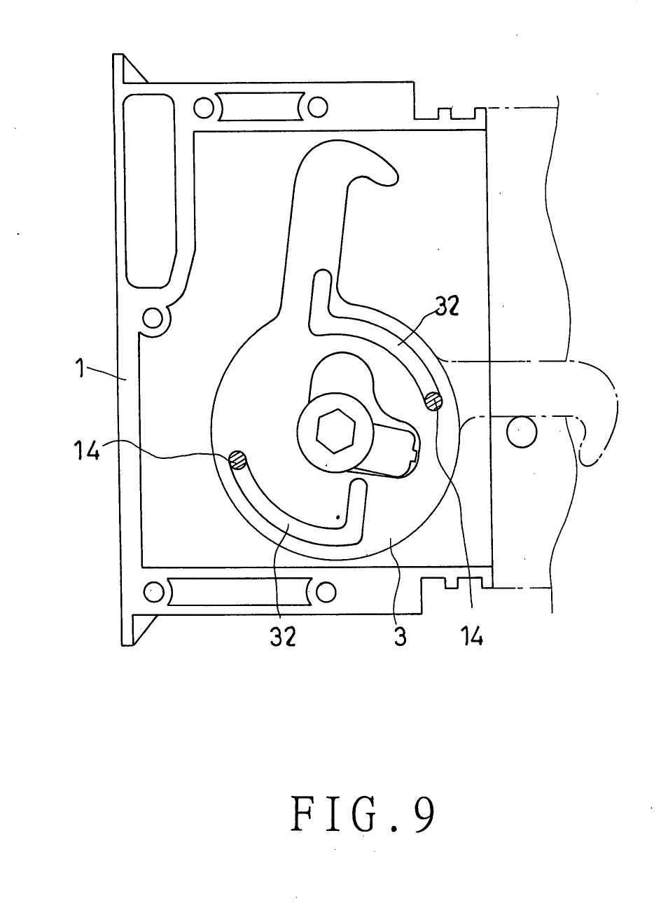

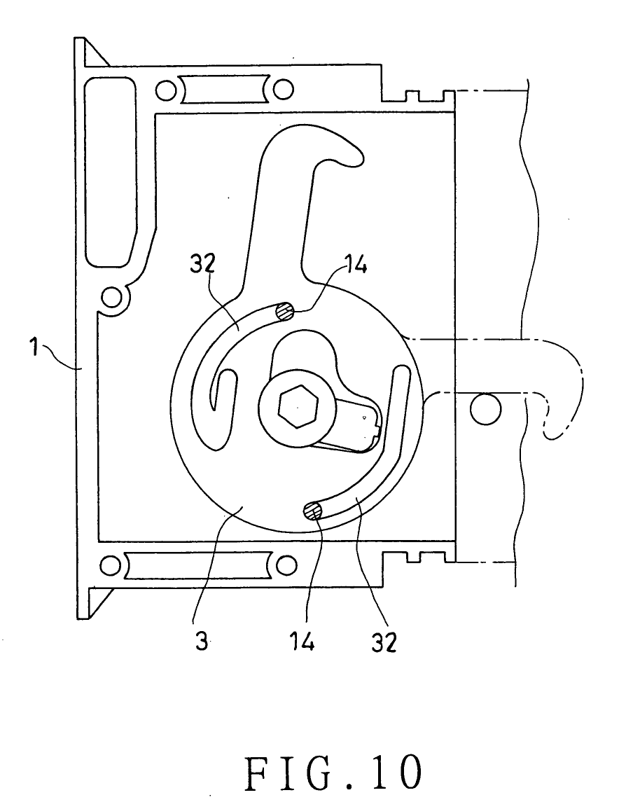

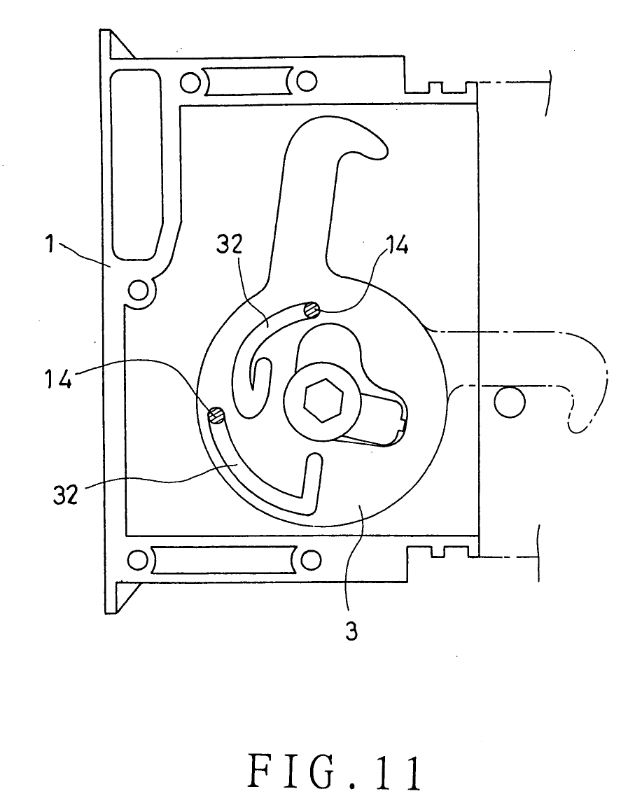

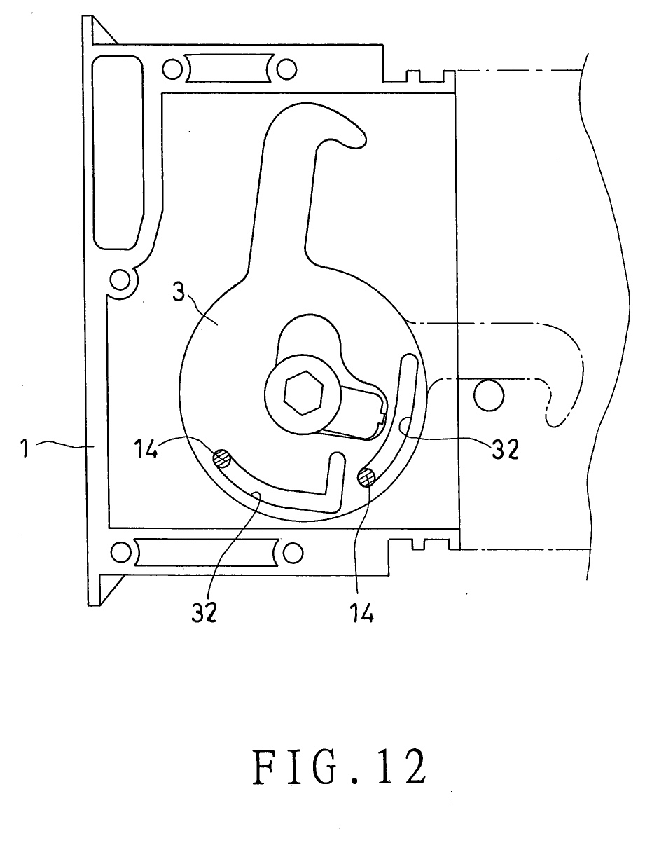

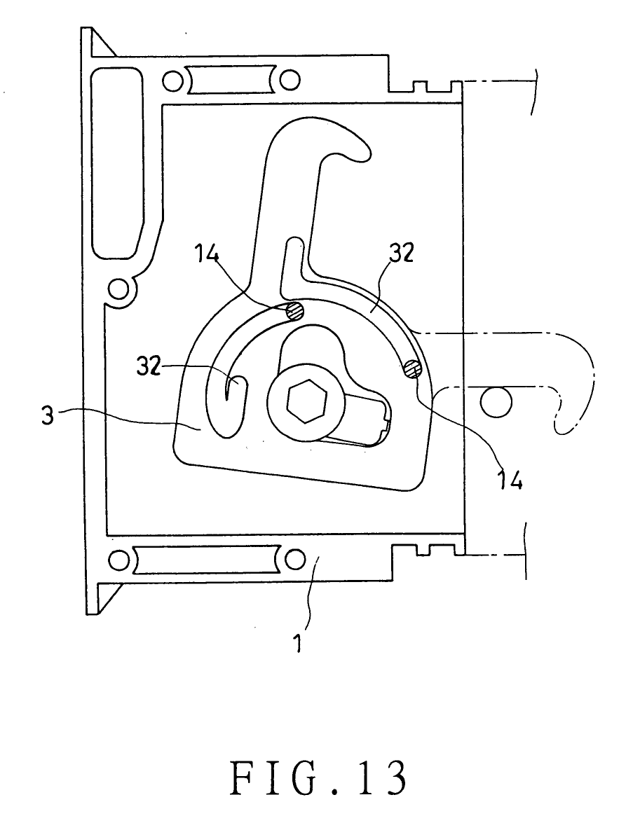

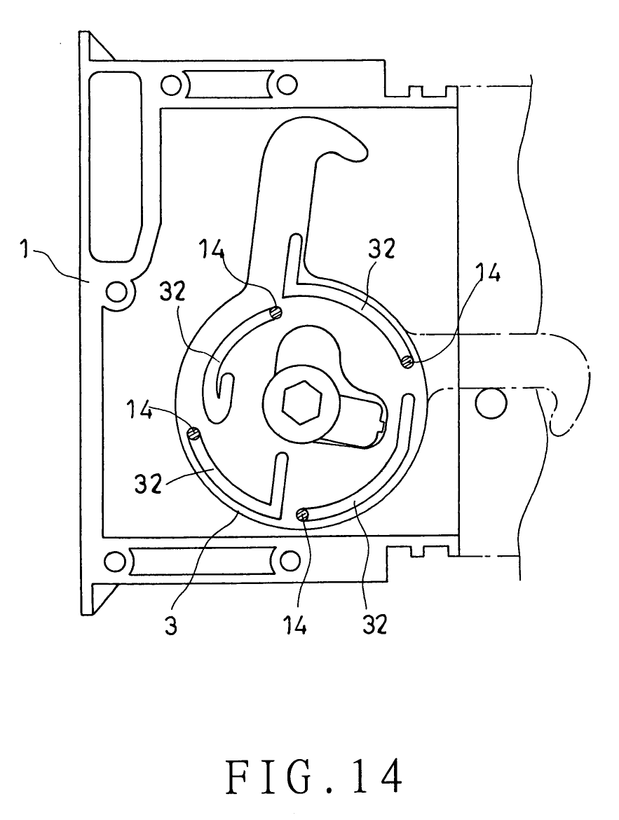

Referring to FIG. 7, a third preferred embodiment of a hooked fastener is provided in the present invention, which includes a holding member 1, and a hooked plate 3; the hooked plate 3 has a guide rail 32, which serves as the only means to guide the hooked plate 3 in order for the guide plate 3 to be tightly hooked over the coupling piece 5. The holding member 1 can be formed with a rail 12 for helping to increase smoothness of motion of the hooked plate 3. In addition, referring to FIG. 8 to FIG. 14, the hooked plate 3 can have at least two (FIG. 8 to FIG. 13) and no more than four (FIG. 14) guide rails 32 to serve as the guiding means instead of the rails 12 of the holding member 1 shown in FIG. 2; each of the guide rails 32 has a corresponding guide rod 14 secured in the holding member 1 and passed through it.

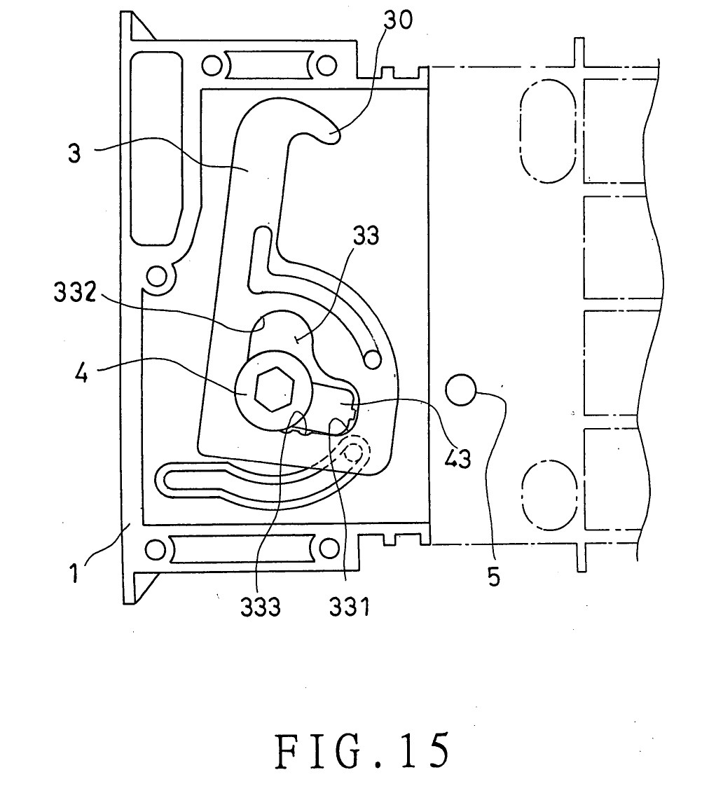

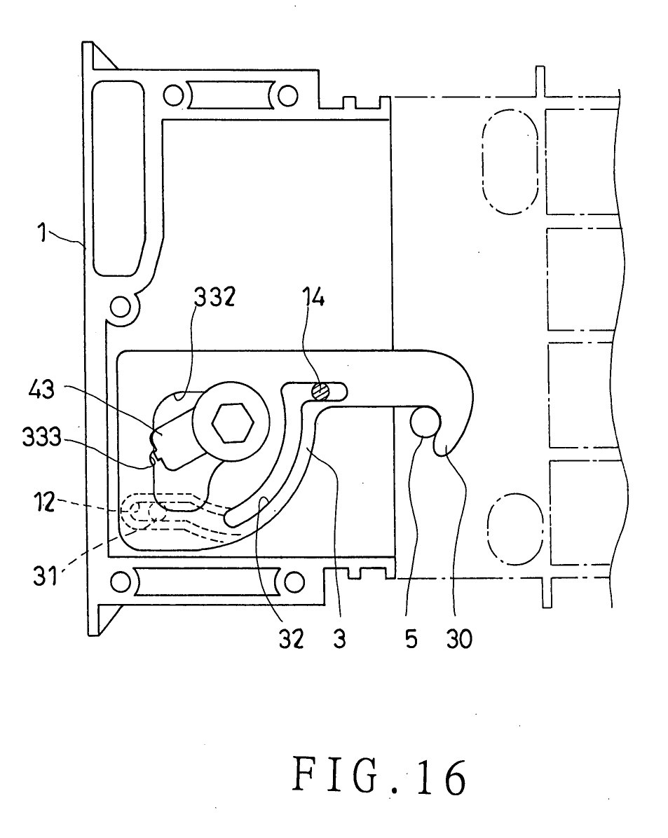

Furthermore, referring to FIG. 15, a fourth preferred embodiment of a hooked fastener of the present invention is provided, wherein the acted section 331 of the position-limiting hollow portion 33 of the hooked plate 3 has at least one detaining recess edge portion 333; after the rotary sleeve 4 has been wrenched so as to make the hook portion 30 of the hooked plate 3 tightly hooked over the coupling piece 5 without making the acting protrusion 43 completely received in the fixing section 332 of the position-limiting hollow portion 33 or making the guide rod 14 and the post-shaped protrusions 31 fixed in the guide rail 32 and the rails 12, the acting protrusion 43 of the rotary sleeve 4 will be tightly pressed against and detained in one said detaining recess edge portion 333 of the position-limiting hollow portion 33, as shown in FIG. 16, to ensure that the two wall plank members are secured together and closely in touch.

From the above description, it can be seen that the hooked fastener of the present invention has the following advantages:

1. The guide rod is passed through the hooked plate, and inserted at two ends thereof in the fixing holes of both the covering part and the holding member to be securely joined to the covering part and the holding member. Therefore, the hooked plate and the covering part can't possibly separate from the holding member when the hooked fastener of the present invention is being used.

2. The hooked plate can move smoothly owing to the rails of the holding member, the post-shaped protrusions and the guide rail of the hooked plate, and the guide rod secured in the holding member, which will serve to guide the hooked plate together when the rotary sleeve is being wrenched by means of a tool.

What is claimed is:

1. An improvement on a structure of a hooked fastener, comprising
a holding member,
a covering part covering said holding member,
a hooked plate fitted between said holding member and said covering part in a movable manner; and
a coupling piece positioned next to said hooked plate for allowing one of both said hooked plate and said coupling piece to be hooked over other one;
said hooked plate having a guide rail on a first side thereof; said holding member and said covering part having a guide rod secured therebetween and passed through said guide rail of said hooked plate; said guide rail of said hooked plate having a curved section for serving together with said guide rod to guide said hooked plate in order for said hooked plate to be angularly displaced;
said guide rail of said hooked plate having a straight section connected to said curved section for serving together with said guide rod to guide said hooked plate in order for said hooked plate to move inwardly so as to be tightly joined to said coupling piece;
said hooked plate having at least one post-shaped protrusion on a second side facing in an opposite direction of said first side thereof;
said holding member having at least one rail; said at least one post-shaped protrusion of said hooked plate being received in a respective said at least one rail of said holding member; said rail of said holding member having a curved section for serving together with said post-shaped protrusion to guide said hooked plate in order for said hooked plate to be angularly displaced;
said rail of said holding member having a straight section connected to said curved section thereof for serving together with said post-shaped protrusion to guide said hooked plate in order for said hooked plate to move inwardly so as to be tightly joined to said coupling piece.

2. An improvement on a structure of a hooked fastener, comprising
a holding member,
a covering part covering said holding member,
a hooked plate fitted between said holding member and said covering part in a movable manner; and
a coupling piece positioned next to said hooked plate for allowing said hooked plate and said coupling piece to be hooked over each other;
said hooked plate having at least one guide rail thereon; said holding member and said covering part having a guide rod secured therebetween and passed through said guide rail of said hooked plate; said at least one guide rail of said hooked plate having a curved section for serving together with said guide rod to guide said hooked plate in order for said hooked plate to be angularly displaced;
said at least one guide rail of said hooked plate having a straight section connected to said curved section thereof for serving together with said guide rod to guide said hooked plate in order for said hooked plate to move inwardly so as to be tightly joined to said coupling piece.

3. The improvement on a structure of a hooked fastener as recited in claim 1 further having a rotary sleeve; said hooked plate having a position-limiting hollow portion; said rotary sleeve being received in said position-limiting hollow portion of said hooked plate; said rotary sleeve having a sleeve part; said rotary sleeve having an acting protrusion protruding from said sleeve part thereof; said position-limiting hollow portion of said hooked plate having an acted section; said position-limiting hollow portion of said hooked plate having a fixing section perpendicular and connected to said acted section thereof as well as being parallel to said straight section of said guide rail of said hooked plate.

4. The improvement on a structure of a hooked fastener as recited in claim 3, wherein said acted section of said position-limiting hollow portion of said hooked plate has at least one detaining recess edge portion for detaining said acting protrusion of said rotary sleeve.

5. The improvement on a structure of a hooked fastener as recited in claim 3, wherein said sleeve part of said rotary sleeve has a wrench hole, and said holding member has a through hole; said sleeve part of said rotary sleeve being partly inserted in said through hole of said holding member; said covering part having a through hole facing said wrench hole of said sleeve part of said rotary sleeve.

6. The improvement on a structure of a hooked fastener as recited in claim 1, wherein a number of said rail is no more than three, and a number of said post-shaped protrusion is no more than three.

7. The improvement on a structure of a hooked fastener as recited in claim 1, wherein said hooked plate is metallic and plate-shaped.

8. The improvement on a structure of a hooked fastener as recited in claim 2 further having a rotary sleeve; said hooked plate having a position-limiting hollow portion; said rotary sleeve being received in said position-limiting hollow portion of said hooked plate; said rotary sleeve having a sleeve part; said rotary sleeve having an acting protrusion protruding from said sleeve part thereof; said position-limiting hollow portion of said hooked plate having an acted section; said position-limiting hollow portion of said hooked plate having a fixing section perpendicular and connected to said acted section thereof as well as being parallel to said straight section of said guide rail of said hooked plate.

9. The improvement on a structure of a hooked fastener as recited in claim 8, wherein said acted section of said position-limiting hollow portion of said hooked plate has at least one detaining recess edge portion for detaining said acting protrusion of said rotary sleeve.

10. The improvement on a structure of a hooked fastener as recited in claim 8, wherein said sleeve part of said rotary sleeve has a wrench hole, and said holding member has a through hole; said sleeve part of said rotary sleeve being partly inserted in said through hole of said holding member; said covering part having a through hole facing said wrench hole of said sleeve part of said rotary sleeve.

11. The improvement on a structure of a hooked fastener as recited in claim 2, wherein a number of said at least one guide rail is no more than four.

12. The improvement on a structure of a hooked fastener as recited in claim 2, wherein said hooked plate is metallic and plate-shaped.
